(19) United States
(12) Patent Application Publication
(10) Pub. No.: US 2010/0017583 A1
(43) Pub. Date: Jan. 21, 2010

(54) Call Stack Sampling for a Multi-Processor System

(75) Inventors: Kean G. Kuiper, Round Rock, TX (US); Frank Eliot Levine, Austin, TX (US); Enio Manuel Pineda, Austin, TX (US); Patrick Chien-Pai Shih, Irvine, CA (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 12/173,047

(22) Filed: Jul. 15, 2008

(51) Int. Cl. G06F 9/30

(52) U.S. Cl. 712/227; 712/E09.032

(57) ABSTRACT

A computer implemented method, apparatus, and computer usable program code for sampling call stack information. Responsive to identifying an interrupt, a determination is made as to whether all processors in a plurality of processors have generated the interrupt. A determination is made as whether to sample the call stack information based on a policy in response to a determination that all of the processors have generated the interrupt. The call stack information is sampled if a determination is made to sample the call stack information based on the policy

### BACKGROUND OF THE INVENTION

1. Field of the Invention

The present disclosure relates generally to an improved data processing system and in particular to a method and apparatus for processing data. Still more particularly, the present disclosure relates to a computer implemented method, apparatus, and computer program code for call stack sampling in a multi-processor data processing system.

2. Description of the Related Art

In writing code, runtime analysis of the code is often performed as part of an optimization process. Runtime analysis is used to understand the behavior of components or modules within the code using data collected during the execution of the code. The analysis of the data collected may provide insight to various potential misbehaviors in the code. For example, an understanding of execution paths, code coverage, memory utilization, memory errors and memory leaks in native applications, performance bottlenecks, and threading problems are examples of aspects that may be identified through analyzing the code during execution.

The performance characteristics of code may be identified using a software performance analysis tool. The identification of the different characteristics may be based on a trace facility of a trace system. A trace tool may use various techniques to provide information, such as execution flows, as well as other aspects of an executing program. A trace may contain data about the execution of code. For example, a trace may contain trace records about events generated during the execution of the code. A trace also may include information, such as a process identifier, a thread identifier, and a program counter. Information in the trace may vary depending on the particular profile or analysis that is to be performed. A record is a unit of information relating to an event that is detected during the execution of the code.

In obtaining trace data, it is a common practice to obtain information about executing threads. This information may include call stack information obtained from call stacks associated with the threads of interest. Call stack information may be obtained from a virtual machine, such as a Java™ virtual machine. Java™ is a trademark of Sun Microsystems, Inc. Many approaches are presently used for obtaining call stack information. These approaches include using entry/exit events, an application timer tick, or instrumenting codes that sample the instrumented values.

### BRIEF SUMMARY OF THE INVENTION

The illustrative embodiments provide a computer implemented method, apparatus, and computer usable program code for sampling call stack information. Responsive to identifying an interrupt, a determination is made as to whether all processors in a plurality of processors have generated the interrupt. A determination is made as whether to sample the call stack information based on a policy in response to a determination that all of the processors have generated the interrupt. The call stack information is sampled if a determination is made to sample the call stack information based on the policy.

### BRIEF DESCRIPTION OF THE SEVERAL VIEWS OF THE DRAWINGS

FIG. 1 is a diagram of a data processing system in which an illustrative embodiment may be implemented;

FIG. 2 is a diagram illustrating components used to obtain call stack information in accordance with an illustrative embodiment;

FIG. 3 is diagram illustrating thread information and a device driver work area in accordance with an illustrative embodiment;

FIG. 4 is a diagram illustrating components to obtain call stack information in accordance with an illustrative embodiment;

FIG. 5 is a diagram of a tree in accordance with an illustrative embodiment;

FIG. 6 is a diagram illustrating information in a node in accordance with an illustrative embodiment;

FIG. 7 is a flowchart of a process for processing interrupts in accordance with an illustrative embodiment;

FIG. 8 is a flowchart of a deferred procedure call in accordance with an illustrative embodiment;

FIG. 9 is a flowchart of the process for obtaining call stack information in accordance with an illustrative embodiment; and

FIG. 10 is a flowchart of a process for collecting call stack information in accordance with an illustrative embodiment.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

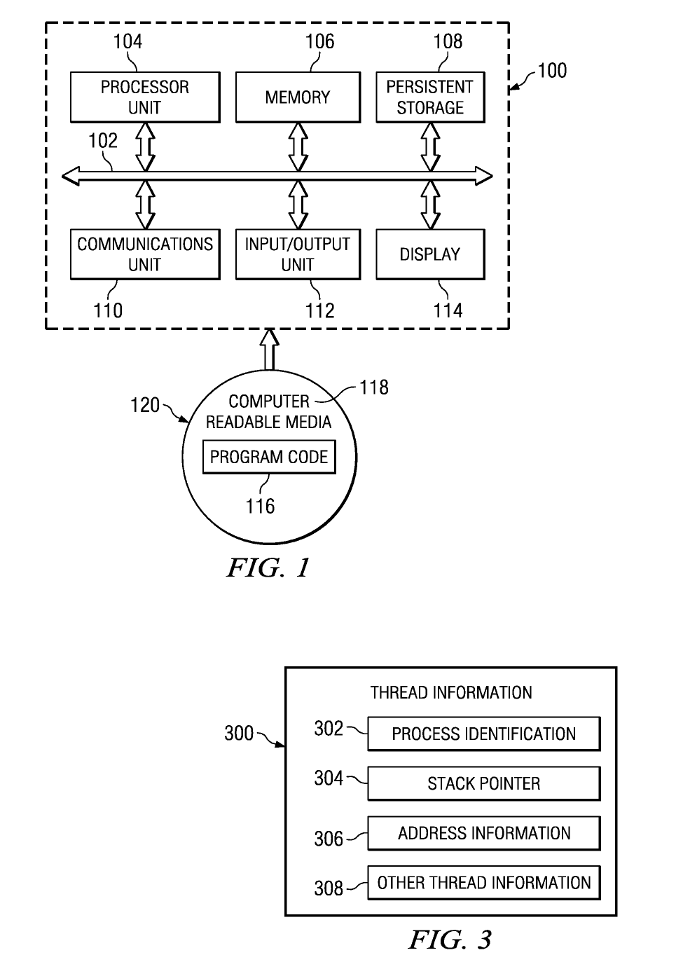

Turning now to FIG. 1, a diagram of a data processing system is depicted in accordance with an illustrative embodiment. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices. A storage device is any piece of hardware that is capable of storing information either on a temporary basis and/or a permanent basis. Memory 106, in these examples, may be, for example, a random access memory or any other suitable volatile or non-volatile storage device. Persistent storage 108 may take various forms depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard and mouse. Further, input/output unit 112 may send output to a printer. Display 114 provides a mechanism to display information to a user.

Instructions for the operating system and applications or programs are located on persistent storage 108. These instructions may be loaded into memory 106 for execution by processor unit 104. The processes of the different embodiments may be performed by processor unit 104 using computer implemented instructions, which may be located in a memory, such as memory 106. These instructions are referred to as program code, computer usable program code, or computer readable program code that may be read and executed by a processor in processor unit 104. The program code in the different embodiments may be embodied on different physical or tangible computer readable media, such as memory 106 or persistent storage 108.

Program code 116 is located in a functional form on computer readable media 118 that is selectively removable and may be loaded onto or transferred to data processing system 100 for execution by processor unit 104. Program code 116 and computer readable media 118 form computer program product 120 in these examples. In one example, computer readable media 118 may be in a tangible form, such as, for example, an optical or magnetic disc that is inserted or placed into a drive or other device that is part of persistent storage 108 for transfer onto a storage device, such as a hard drive that is part of persistent storage 108. In a tangible form, computer readable media 118 also may take the form of a persistent storage, such as a hard drive, a thumb drive, or a flash memory that is connected to data processing system 100. The tangible form of computer readable media 118 is also referred to as computer recordable storage media. In some instances, computer readable media 118 may not be removable.

Alternatively, program code 116 may be transferred to data processing system 100 from computer readable media 118 through a communications link to communications unit 110 and/or through a connection to input/output unit 112. The communications link and/or the connection may be physical or wireless in the illustrative examples. The computer readable media also may take the form of non-tangible media, such as communications links or wireless transmissions containing the program code.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown.

As one example, a storage device in data processing system 100 is any hardware apparatus that may store data. Memory 106, persistent storage 108 and computer readable media 118 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

The different illustrative embodiments recognize that in a data processing system having multiple processors, timer interrupts may be generated. These interrupts may be generated using a timer in which an inter-processor interrupt is sent to all the processors. The different illustrative embodiments recognize that it is desirable to obtain all of the interrupts at a predetermined rate or with some amount of time. Programmed hardware in the processors may provide these inter-processor interrupts to all of the processors. For example, many processors have advanced programmable interrupt controllers. In particular, these types of controllers may be found in processors available from Intel Corporation. These advanced programmable interrupt controllers may be used to generate inter-processor interrupts. The different illustrative embodiments recognize that when an interrupt is generated, it is desirable to prevent or reduce any forward progress in the execution of an application. The call stack information should be obtained prior to allowing the application to run again. The different illustrative embodiments recognize that if the interrupts generated by the different processors are staggered far enough apart, the data processing system may spend too much time attempting to get samples and not obtain the samples at a fast enough rate.

Thus, the different illustrative embodiments provide a computer-implemented method, apparatus, and computer usable program code for sampling call stack information. In response to identifying interrupt, a determination is made as to whether all the processors in a plurality of processors have generated the interrupt. If all of the processors have generated the interrupt, a determination is made as to whether to sample call stack information based on the set of criteria. The call stack's information is sampled if a determination is made to sample the call stack information using the set of criteria. A set as used herein refers to one or more items. For example, a set of criteria refers to one or more criteria. As another example, a set of threads refers to one or more threads. If all of the processors have not generated an interrupt, the process continues to wait until interrupts have been received from all of the processors. In these examples, when an interrupt is received from a processor, that processor may be placed into a state that prevents or reduces any further execution of forward progress in the instructions being executed for an application.

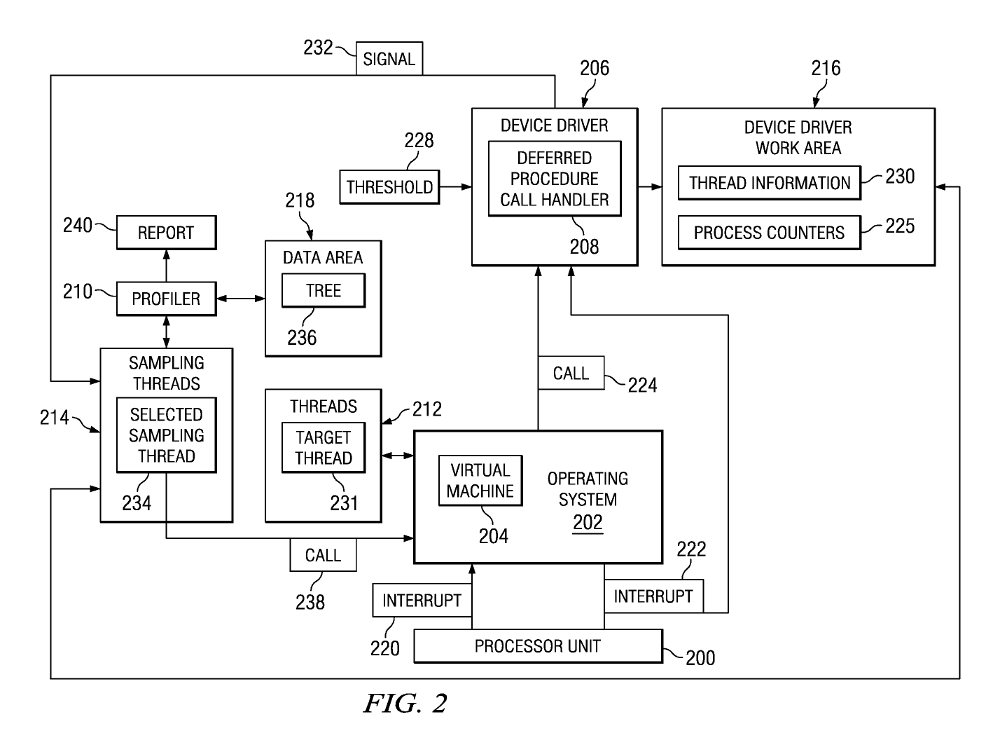

With reference to FIG. 2, a diagram illustrating components used to obtain call stack information is depicted in accordance with the illustrated embodiment. In the depicted example, the components are examples of hardware and software components found in the data processing system, such as data processing system 100 in FIG. 1.

These components include processor unit 200, operating system 202, virtual machine 204, device driver 206, deferred procedure call handler 208, profiler 210, threads 212, sampling threads 214, device driver work area 216, and data area 218.

Processor unit 200 is similar to processor unit 104 in FIG. 1 and may generate interrupts, such as interrupts 220 and 222 from processors within processor unit 200. These interrupts may be, for example, without limitation, timer interrupts.

In particular, interrupt 220 and interrupt 222 may be generated based on timed interrupts that may be initiated for all of the processors within processor unit 200. In these examples, this type of interrupt may be generated using an advanced programmable interrupt controller within each processor and processor unit 200.

The interrupts may be passed to device driver 206 in a number of different ways. For example, interrupt 220 is passed to device driver 206 through call 224. Alternatively, interrupt 222 is passed directly to device driver 206 via an Interrupt Vector Table (IVT). After receiving an interrupt, device driver 206 may process the interrupt using a deferred procedure call (DPC) to deferred procedure call handler 208 located within device driver 206. Of course, other routines or processes may be used to process these interrupts. The deferred procedure call initiated by device driver 206 is used to continue processing interrupt information from interrupt 222.

In another embodiment, a dispatcher in operating system 202 may record the process and thread information of the dispatched process in a per processor work area and this information may be used to determine the threads for which call stacks are obtained.. In this embodiment, deferred procedure call handlers may be initiated on all processors by one specific processor interrupt handler. Alternatively, one processor may be identified to process the interrupt and interprocessor interrupt (IPI) may be used for interrupting the other processors.

In yet another embodiment, the interrupt handlers may determine if all processors are synchronized to be processing an interrupt by simply looping until it is determined that all the processors have entered the interrupt state.

In the different illustrative embodiments, deferred procedure call handler 208 determines whether all of the processors with processor unit 200 have generated an interrupt in response to device driver 206 receiving interrupt 222 or call 224. Deferred procedure call handler 208 may update a counter within processor counters 225 in device driver work area 216. Each processor counter within processor counters 225 may be associated with a particular processor in processor unit 200. Processor counters 225 also may be referred to as flags. One implementation may involve atomically ORing a bit in a word identifying the processor currently being interrupted and comparing the word to the active processor set.

More specifically, deferred procedure call handler 208 determines whether the interrupt received from the processor has a counter set in processor counts 225. If the counter is not set for the processor, deferred procedure call handler 208 sets that counter. Next, deferred procedure call handler 208 determines whether all of processor counters 225 have been set. If all of processor counters 225 have not been set, deferred procedure call handler 208 loops until all the processors have taken an interrupt or a determination has been made that there is a problem. If a problem is a detected, for example, by determining that the elapsed time has exceeded a threshold, then either the process is terminated or an attempt is made to reset the interrupt processing.

By looping, deferred procedure call handler 208 places that processor into a state in which the processor does not execute instructions for an application. In addition, differed procedure call handler 208 may also initiate high priority sampler threads on each processor reducing the amount of forward progress made by the monitored application. These sampler threads may be retrieving call stacks or may run in a “spin loop” until execution of that thread is terminated. As a result, the forward progress of the application is eliminated or reduced. In some cases, the application must progress to a state in which the call stack may be retrieved.

If interrupts have been received from all of the processors within processor unit 200, deferred procedure call handler 208 may then determine whether call stack information should be obtained. This determination may be made using policy 228. Policy 228 may be a set of rules identifying what actions to take. For example, policy 228 may specify that call stacks will be obtained only if a virtual machine 204 is interrupted or if there is no sampling in process. Determination of sampling in process may be made by verifying that the interrupt is not in a sampling thread and all of sampling threads 214 are blocked and waiting for work. As another example, policy 228 may specify that call stack information should not be obtained if the interrupt occurs when a sampling thread is executing on a processor. In either event, the fact that a sampling process is occurring or that a sampling thread was encountered when an interrupt occurred may be identified for later processing. For example, the occurrence of one of these two conditions may be identified by incrementing a counter for the particular condition.

If device driver 206 determines that call stack information should be obtained through processing of the interrupt by deferred procedure call handler 208, initiation of call stack sampling information may be made for a thread such as, for example, target thread 231 and threads 212. Device driver 206 may send signal 232 to sampling threads 214. Signal 232 may wake selected sampling thread 234 to obtain call stack information.

Selected sampling thread 234 may obtain information from thread information 230 in device driver work area 216 and place the information into data area 218. Selecting sampling thread 234 may access device driver work area 216 through a pointer passed to the sampling thread in signal 232 by device drive 206.

This information may be placed into tree 236 for later analysis. Further, selected sampling thread 234 also may send call 238 to virtual machine 204 to obtain call stack information. This call is made through a virtual machine interface to virtual machine 204. In these examples, the virtual machine interface may be, for example, without limitation, the Java® Virtual Machine profiler interface (JVMPI) or Java® Virtual Machine tool interface (JVMTI) specifications may be monitored. These interfaces will return call stack information to sampling thread 234 or may store it in some work area. In these examples, virtual machine 204 may take the form of a Java™ virtual machine. Of course, other virtual machines may be used depending on a particular implementation. These types interfaces are examples of interfaces that may be used to access a virtual machine and are referred to generally as virtual machine interfaces.

Virtual machine 204 may be, for example, a Java™ virtual machine. Of course, virtual machine 204 may take the form of any other type of virtual machine, depending on the particular implementation.

Selected sampling thread 234 takes the call stack information obtained from virtual machine 204 and places this information into tree 236 for analysis. Additionally, tree 236 contains call stack information and other information, such as, number of samples. Tree 236 also may include information about each leaf node, which was the last routine being executed on that thread at the time the call stack was retrieved. After call stack information has been collected, profiler 210 may generate report 240. Report 240 is a presentation of information stored within tree 236 in data area 218.

With reference now to FIG. 3, a diagram illustrating thread information and a device driver work area as depicted in accordance with an illustrative embodiment. In this example, thread information 300 is a more detailed example of thread information 230 in FIG. 2. As illustrated, thread information 300 includes process identification 302, stack pointer 304, address information 306, and other thread information 308. This thread information may be used to obtain call stack information for a particular thread. Further, this information may be used by deferred procedure call handler 208 along with policy 228 to determine whether call stack information should be obtained. Also, this information may be used to identify a particular target thread for which call stack information may be obtained.

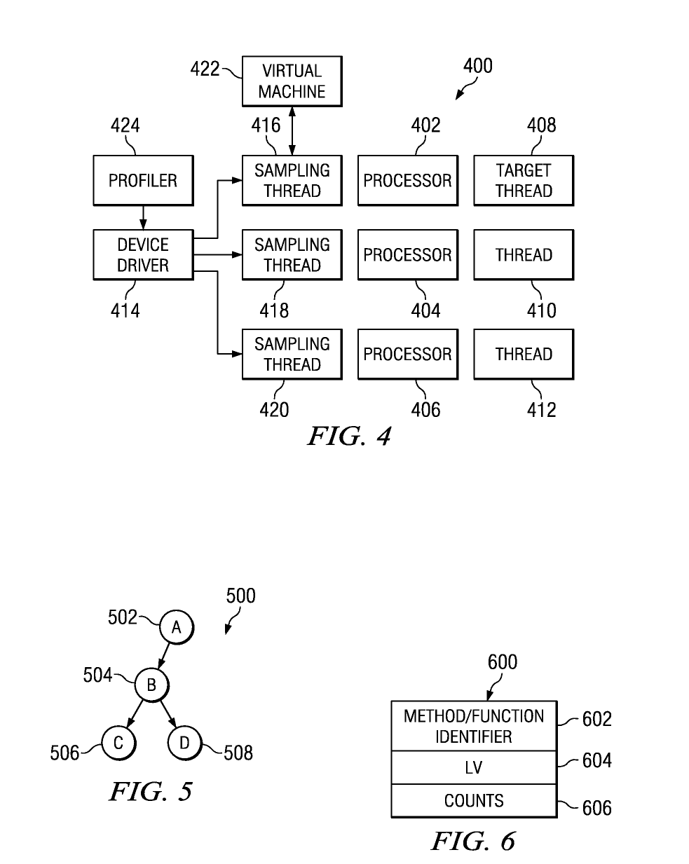

Turning now to FIG. 4, a diagram illustrating components to obtain call stack information is depicted in accordance with an illustrative embodiment. In this example, data processing system 400 includes processors 402, 404, and 406. These processors are examples of processors that may be found in processor unit 200 in FIG. 2. During execution, each of these processors has threads executing on them in the depicted examples. In other examples, one or more processors may be in an idle state in which no threads are executing on these processors.

When an interrupt occurs, target thread 408 is executing on processor 402; thread 410 is executing on processor 404; and thread 412 is executing on processor 406. In these examples, target thread 408 is the thread interrupted on processor 402. For example, the execution of target thread 408 may be interrupted by a timer interrupt or hardware counter overflow, where the value of the counter is set to overflow after a specified number of events, for example, after 100,000 instructions are completed.

When an interrupt is generated, device driver 414 determines whether to send a signal to a selected sampling thread in sampling threads 416, 418, and 420. In these examples, device driver 414 determines whether all of the processors have generated interrupts. If all of processors 402, 404, and 406 have generated interrupts, device driver 414 may then determine whether to obtain call stack information using a policy as described above.

Each of these sampling threads is associated with one of the processors. In this example, sampling thread 418 is associated with processor 404, sampling thread 420 is associated with processor 406, and sampling thread 416 is associated with processor 402.

One of these sampling threads is woken by device driver 414 when the sampling criteria is met. In these examples, device driver 414 is similar to device driver 206 in FIG. 2. In this example, target thread 408 is the thread of interest for which call stack information is desired.

In the depicted examples, device driver 414 sends a signal to one or more of sampling threads 416, 418, and 420 to obtain call stack information. In this example, sampling thread 416 is woken by device driver 414 to obtain call stack information for target thread 408.

The call stack information may be obtained by making appropriate calls to virtual machine 422. In these examples, virtual machine 422 is a Java™ virtual machine. In these examples, the interface used to make calls is the Java™ Virtual Machine Tools Interface (JVMTI). This interface allows for the collection of call stack information. The call stacks may be, for example, used to create standard trees containing count usage for different threads or methods. The Java™ Virtual Machine Tool interface is an interface that is available in Java™ 5 software development kit (SDK), version 1.5.0. The Java™ Virtual Machine Profiler Interface (JVMPI) is available in Java™ 2 platform, standard edition (J2SE) SDK version 1.4.2. These two interfaces allow processes or threads to obtain information from the Java™ virtual machine. Descriptions of these interfaces are available from Sun Microsystems, Inc. Either interface, or any other interface to a Java™ virtual machine, may be used to obtain call stack information for one or more threads in this particular example. Call stack information obtained by sampling thread 416 is provided to profiler 424 for processing. A call tree is constructed from the call stack obtained from virtual machine 422 at the time of a sample. The call tree may be constructed by monitoring method/functions entries and exits. In these examples, however, tree 500 in FIG. 5 is generated using samples obtained by a sampling thread, such as sampling thread 416 in FIG. 4.

Turning to FIG. 5, a diagram of a tree is depicted in accordance with an illustrative embodiment. Tree 500 is a call tree and is an example of tree 236 in FIG. 2. Tree 500 is accessed and modified by an application, such as profiler 210 in FIG. 2. In this depicted example, tree 500 contains nodes 502, 504, 506, and 508. Node 502 represents an entry into method A, node 504 represents an entry into method B, and nodes 506 and 508 represent entries into method C and D, respectively. Each of these nodes may include call stack information as well as sample counts associated with a particular thread for a method.

With reference now to FIG. 6, a diagram illustrating information in a node is depicted in accordance with an illustrative embodiment. Entry 600 is an example of information in a node, such as node 502 in FIG. 5. In this example, entry 600 contains method/function identifier 602, tree level (LV) 604, and sample count 606.

The information within entry 600 is example information that may be determined for a node within a tree. For example, method/function identifier 602 contains the name of the method or function. Tree level (LV) 604 identifies the tree level of the particular node within the tree. For example, with reference back to FIG. 5, if entry 600 is for node 502 in FIG. 5, tree level (LV) 604 would indicate that this node is a root node. Sample count 606 may include accumulated counts for a node on a thread.

When the profiler is signaled, the profiler may request that a call stack be retrieved for each thread of interest. Each call stack that is retrieved is walked into a call stack tree and each sample or changes to metrics that are provided by the device driver are added to the leaf node's base metrics, which may be the count of samples of occurrences for a specific call stack sequences. In other embodiments, the call stack sequences may simply be recorded.

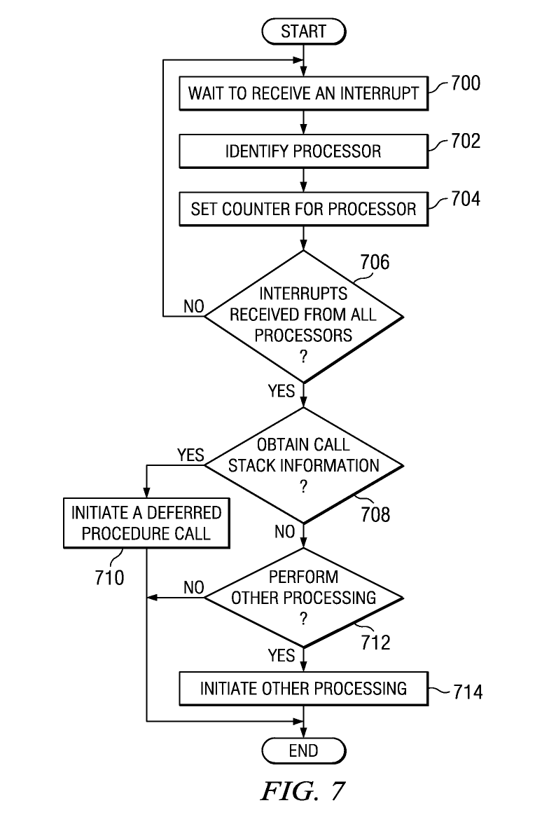

With reference now to FIG. 7, a flowchart of a process for processing interrupts is depicted in accordance with an illustrative embodiment. In this example, process 700 may be implemented in such a component, such as, for example, deferred procedure call handler 208 in FIG. 2.

The process begins by receiving an interrupt (step 700). This interrupt may be received directly from the processor or through the operating system depending on the particular implementation. The process then identifies the processor generating the interrupt (step 702). Thereafter, the process sets a counter for the processor (step 704). The looping through steps 700, 702, 704, and 706 prevent the forward progress.

A determination is then made as to whether interrupts have been received from all of the processors (step 706). This determination may be made by checking the different counters to see whether all of the counters have been set for the different processors. If interrupts have not been received from all the processors, the process returns to step 700 to wait to receive another interrupt. If interrupts have been received from all of the processors, a determination is made as to whether to obtain call stack information (step 708). The determination may be made using a policy such as policy 228 in FIG. 2.

If call stack information is to be obtained, the process initiates a differed procedure call for each processor (step 710) with the process terminating thereafter. This differed procedure call is used by the device driver to prevent forward progress in execution and to initiate call stack sampling. For example, the events may be a signal sent to a sampling thread such as signal 232 in FIG. 2.

With reference again to step 708, if call stack information is not to be obtained, a determination is made as to whether other processing is to be performed (step 712). If other processing is to be performed, this other processing is initiated (step 714) with the process terminating thereafter.

With reference again to step 712, if other processing is not to be performed, the process terminates. In these examples, call stack information may not be obtained for a number of different reasons, depending on the policy used.

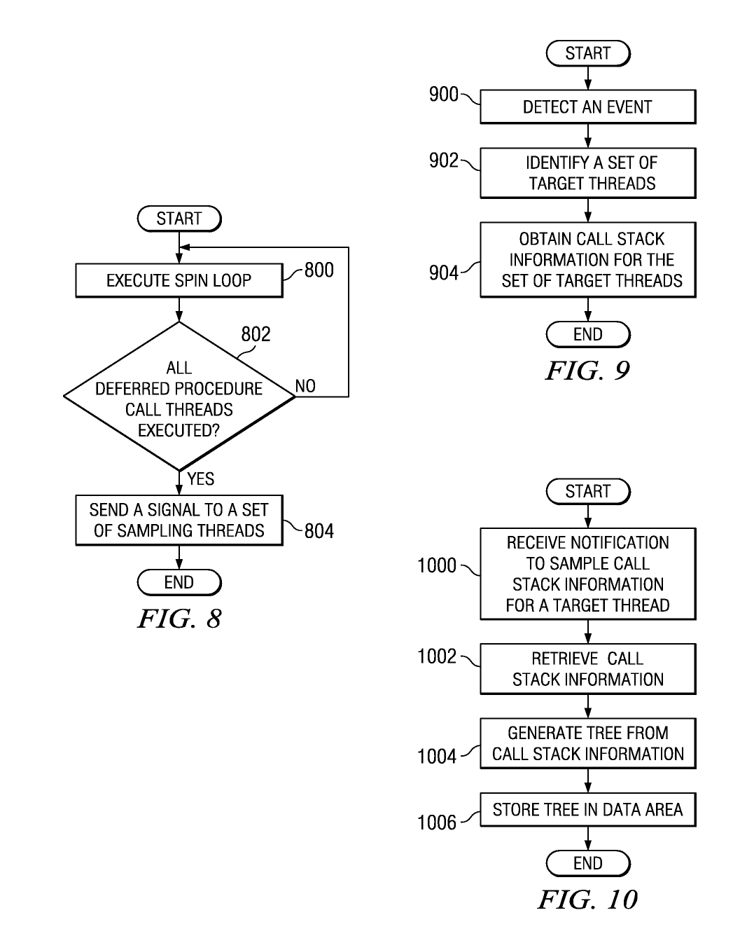

Turning next to FIG. 8, a flowchart of a deferred procedure call is depicted in accordance with an illustrative embodiment. In these examples, the process in FIG. 800 is an example of a process that may be executed by a deferred procedure call in accordance with an illustrative embodiment.

The process begins by executing a spin loop (step 800). In this step, the deferred procedure call thread executes on the processor at a priority that is higher than the sampling threads at a priority that is lower than an interrupt. The spin loop may be a loop that occurs until the deferred procedure call thread is to be terminated. In this manner, the deferred procedure call thread may keep the processor busy to prevent any forward progress in the execution of an application.

The process then determines whether all of the deferred procedure call threads are executing (step 802). This determination may be made by accessing a work area in which the deferred procedure call handler threads may register. This work area may be, for example, device driver work area 216 or some other work area that may be provided through the operating system. If all of the deferred procedure call threads are not executing, the process returns to step 800.

Otherwise, a signal is sent to a set of sampling threads (step 804) with the process terminating thereafter. In these examples, step 804 may be performed by only one of the deferred procedure call threads. This deferred procedure call thread may obtain ownership of sampling and send a signal to the set of sampling threads to initiate collection of call stack information. In other embodiments, each deferred procedure call thread may send a signal to an associated sampling thread.

With reference now to FIG. 9, a flowchart of the process for obtaining call stack information is depicted in accordance with an illustrative embodiment. This process may be implemented in a software component such as a sampling thread in response to a signal being generated by a deferred procedure call. The process begins by detecting a signal (step 900). This event may be generated by the deferred procedure call handler making a determination that call stack information should be collected. The process then identifies a set of target threads (step 902). These target threads may be used to identify a set of criteria that may be found in policy 228 in FIG. 2 in these examples. The process then obtains call stack information for the set of target threads (step 904) with the process terminating thereafter.

With reference now to FIG. 10, a flowchart of a process for collecting call stack information is depicted in accordance with an illustrative embodiment. In this example, the process may be implemented in a software component such as a virtual machine.

The process begins by receiving a notification to sample call stack information for a target thread (step 1000). The call stack information is then retrieved (step 1002). Next, a tree is generated from the call stack information (step 1004). In this example, the tree may be tree 500 in FIG. 5. This tree is stored in a data area (step 1006) with the process terminating thereafter. In these examples, this data area may be data area 218 in FIG. 2. Some sampler threads may simply loop while other sampler threads are getting call stacks. The looping terminates when all the call stacks from the other sampling threads have been retrieved and/or processed.

Thus, the different illustrative embodiments provide a computer-implemented method, apparatus, and computer usable program code for sampling call stack information. In the different illustrative examples, a determination is made as to whether all processors in the plurality of processors have generated an interrupt when an interrupt is identified or received. If all of the processors have generated an interrupt, a determination is made as to whether call stack information should be sampled based on a policy. The call stack information is sampled if the determination is made to sample that call stack information using the policy.

The different illustrative embodiments provide a capability to selectively perform call stack sampling even if all of the processors have generated interrupts. Different types of processing other than call stack sampling may occur, depending on the various conditions or parameters. Of course, other types of criteria or rules may be used to determine whether to collect call stack information and what processing to perform in other implementations and these examples are not meant to limit the manner in which that type of processing and determination may be made.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer usable or computer readable medium providing program code for use by or in connection with a computer or any instruction execution system. For the purposes of this description, a computer usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for sampling call stack information, the computer implemented method comprising:
responsive to identifying an interrupt, determining whether all processors in a plurality of processors have generated the interrupt;
responsive to a determination that all of the processors in the plurality of processors have generated the interrupt, determining whether to sample the call stack information based on a policy; and
sampling the call stack information if a determination is made to sample the call stack information based on the policy.

2. The computer implemented method of claim 1 further comprising:
performing an alternative action in response to a determination not to sample call stack information based on the policy.

3. The computer implemented method of claim 1, wherein the policy specifies that if an interrupted thread on a processor is a sampling thread, the call stack information is not obtained for the sampling thread.

4. The computer implemented method of claim 3, wherein a counter is incremented indicating that the sampling thread was executing when the interrupt occurred.

5. The computer implemented method of claim 1, wherein the policy specifies that if sampling of call stacks is currently occurring that sampling of the call stack information is not performed.

6. The computer implemented of claim 5, wherein a counter is incremented indicating that the interrupt occurred while sampling is currently running.

7. The computer implemented method of claim 1, wherein the determination to sample the call stack is based on at least one interrupt of a specified process.

8. The computer implemented method of claim 1, wherein a process identifier and a thread identifier are stored in a data area at dispatch time and the process identifier and the thread identifier are compared to the policy to determine if any call stacks are to be retrieved.

9. The computer implemented method of claim 1, wherein the sampling step comprises:
sampling the call stack information using a virtual machine interface if a determination is made to sample the call stack information based on the policy.

10. The computer implemented method of claim 1, wherein the sampling step comprises:
executing a set of sampling threads on the plurality of processors, wherein forward progress in execution of an application reduced by the set of sampling threads executing on the plurality of processors while sampling of the call stack information is occurring.

11. The computer implemented method of claim 1 further comprising:
responsive to a determination that the all processors in the plurality of processors have not generated the interrupt, setting a counter for the processor in the plurality of processors generating the interrupt.

12. A data processing system comprising:
a bus;
a communications unit connected to the bus;
a storage device connected to the bus, wherein the storage device includes program code; and
a processor unit connected to the bus, wherein the processor unit executes the program code to determine whether all processors in a plurality of processors have generated the interrupt in response to identifying the interrupt; determine whether all processors in the plurality of processors have generated the interrupt, in response to identifying an interrupt; determine whether to sample the call stack information based on a policy in response to a determination that all of the processors in the plurality of processors have generated the interrupt; and sample the call stack information if a determination is made to sample the call stack information based on the policy.

13. The data processing system of claim 12, wherein the processor unit further executes the program code to perform an alternative action in response to a determination not to sample call stack information based on the policy.

14. The data processing system of claim 12, wherein the policy specifies that if an interrupted thread on a processor is a sampling thread, the call stack information is not obtained for the sampling thread.

15. The data processing system of claim 14, wherein a counter is incremented indicating that the sampling thread was executing when the interrupt occurred.

16. The data processing system of claim 12, wherein the policy specifies that if sampling of call stacks is currently occurring that the sampling of the call stack information is not performed.

17. A computer program product comprising:
a computer usable medium having computer usable program code for sampling call stack information, the computer program product comprising:
a computer recordable storage medium;
program code, stored on the computer recordable storage medium, responsive to identifying an interrupt, for determining whether all processors in a plurality of processors have generated the interrupt;
program code, stored on the computer recordable storage medium, responsive to a determination that all of the processors in the plurality of processors have generated the interrupt, for determining whether to sample the call stack information based on a policy; and
program code, stored on the computer recordable storage medium, for sampling the call stack information if a determination is made to sample the call stack information based on the policy.

18. The computer program product of claim 17 further comprising:
program code, stored on the computer recordable storage medium, for performing an alternative action in response to a determination not to sample call stack information based on the policy.

19. The computer program product of claim 17, wherein the policy specifies that if an interrupted thread on a processor is a sampling thread, the call stack information is not obtained for the sampling thread.

20. The computer program product of claim 19, wherein a counter is incremented indicating that the sampling thread was executing when the interrupt occurred.
